(19) United States
(12) Patent Application Publication
(10) Pub. No.: US 2008/0286428 A1
(43) Pub. Date: Nov. 20, 2008

(54) Method for Manufacturing Feedstuff

(75) Inventors: Urs Wüest, Kronbühl (CH); Heinrich Broring, Dinklage (DE)

Correspondence Address: MERCHANT & GOULD PC, P.O. BOX 2903, MINNEAPOLIS, MN, 55402-0903, US

(73) Assignee: Bühler AG, Uzwil (CH)

(21) Appl. No.: 11/664,488

(22) PCT Filed: Oct. 24, 2005
(86) PCT No.: PCT/CH2005/000622

§ 371 Date: Jan. 17, 2008

(30) Foreign Application Priority Data
Nov. 18, 2004 (DE) 10 2004 055 792.6

(51) Int. Cl. A23K 1/18; A23N 17/00

(52) U.S. Cl. 426/442; 99/487; 23/313 R; 99/485

(57) ABSTRACT

A method for producing feedstuff, in particular pelletized feedstuff for chicken and pigs includes thermally holding pellets at a pellet press output and in post-conditioning said pellets in a rear container (6). Afterwards, the pellets come from the rear container (6) to a mixer (7), wherein liquids can be added without cooling. Drying and cooling are carried out afterwards, the pellets being transferred to a crumbler.

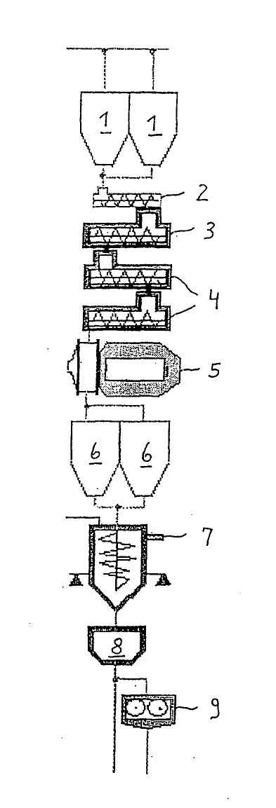

The invention relates to a method for manufacturing feedstuff, in particular pelleted feedstuff for chickens or pigs.

EP-B-923877 describes a method for manufacturing granulated animal feed, wherein the parent material is first heated and then pelleted. After a cooling and drying phase, the pellets are stored and packaged. In a process similar to IE-A-930995, a crumbler and sifting of fines follow the cooler. According to EP-A-257996, premix-pellets are dried with warm air and subsequently cooled.

In a method for the hygienizing, thermal treatment of flour according to WO 00/60958, in particular feed flours are heated in a first heatable batch mixer, and then proceed directly into a dryer/cooler. In a second, downstream batch mixer, additives can be mixed in with the dried and cooled flour.

DE-A-10105344 discloses a two-stage cooling of pellets of the like, in which the pellets are preliminarily cooled in a first stage, wherein only approx. ⅓ of the entire cooling time is required to cool the pellets to under 60° C. Only once sifting and/or breaking is complete does the slower post-cooling process take place.

The object of the invention is to develop a method for manufacturing feedstuffs with which in particular pelleted feed for chickens or pigs can be subsequently treated in an efficient and environmentally conscious manner. The object is achieved with the features in claim 1. To this end, the pellets are post-conditioned immediately after the pelleting press without any significant heat loss, and various liquids are added e.g., via moistening or greasing, in particular with fats and/or enzymes. Only thereafter are the pellets cooled and, if necessary, broken up.

The subclaims disclose advantageous embodiments.

The method makes it possible to grease feed pellets warm and with little fat loss, or generally add liquid quantities with virtually no losses and under hygienizing conditions.

Another object is to provide an arrangement for implementing the method for manufacturing feedstuff. This object is achieved with the features in claim 6. Situated downstream from the pellet press is a heatable post-container, in which post-conditioning takes place. This post-container is followed by a heatable mixer, which is also suitable for adding liquids. Advantageous embodiments are disclosed in the accompanying subclaims.

The method and device make it possible to save energy during hygienization by using frictional heat during the pelleting process, and by reducing the hygienization temperature owing to the longer retention time, in particular in the retention unit. Also enabled is an odor reduction in the cooler exhaust air, and a lowering of fat losses via the exhaust air. Using a vacuum mixer before the cooler pre-dries the 70° C. to 90° C. pellets, and cools them to approx. 35° C. to 40° C. During post-cooling, significantly fewer odoriferous substances are released. The usual fat or oil losses of 0.2-1.0% can be decisively reduced. Additional odor reduction systems, e.g., wet washers, need not be used.

Adding fat in the vacuum mixer makes it possible to increase the fat quantity, the penetration depth of the fat into the approx. 40° C. pellets rises, and the recipe costs drop.

The invention will be described in greater detail below based on a drawing. The drawing is a FIGURE showing part of a feed mill with pelleting press system. Broiler feed (pellets with a diameter of approx. 3.0-3.2 mm) are to be fabricated.

The pelleting press system contains at least one silo 1 for the prepared and mixed parent products for feed pellets. Situated downstream from the silo 1 are a metering device 2, a vapor conditioner 3 and one to two retention units 4, followed by a pelleting press 5, as disclosed in WO 03/081155 of the applicant.

Situated downstream from the product outlet of the pelleting press 5 is a heatable post-container 6, followed by an also heatable mixer 7, e.g., a vertical mixer, which makes it possible to supply in particular non-aqueous liquids to the pellets. This mixer can also be suitable for use as a vacuum coater or dryer, e.g., as a vacuum dryer, or be designed as such.

The mixer 7 is also preferably supported on weighing elements.

The mixer 7 is followed by a conventional cooler 8 and then a cube crusher 9.

If necessary, two or more such arrangements can be provided. During the cooling process, aqueous moisture can be simultaneously removed from the pellets.

The pellets manufactured in the pelleting press 5 lose no temperature in getting directly into the post-container 6, where they are hygienized or post-conditioned and intermediately stored while retaining the pallet temperature, until the mixer 7 can accommodate the next batch. Liquids, including fats, can be introduced in the mixer 7. Fat content can be increased by up to 10%.

Situating a vacuum mixer (7) in front of the cooler 8 subjects the approx. 70-90° C. hot pellets to pre-drying, and also cooling to 35-40° C. During subsequent post-cooling in the cooler 8, in particular a countercurrent cooler, significantly fewer odiferous substances are released than in prior art, the amount of exhaust air is reduced, and oil and fat losses are greatly diminished.

1. A method for manufacturing feedstuff for chickens or pigs, wherein parent substances are mixed and conditioned before pelleting, and the resultant pellets are cooled, wherein the pellets are post-conditioned or hygienized immediately after the pelleting process, and subsequently treated or enhanced while still in a warm state through the addition of liquid.

2. The method according to claim 1, wherein the post conditioned and moistened pellets, greased with fat and/or enzymes, are dried and cooled.

3. The method according to claim 1 wherein post conditioning and moistening take place in respectively heated containers.

4. The method according to claim 1, wherein post-conditioning and moistening take place while at least retaining the temperature the pellets had when exiting the pelleting press.

5. The method according to claim 1, wherein the pellets are moistened during a mixing process.

6. A device for manufacturing feedstuff, in particular pelleted feedstuff, suitable for implementing a method according to claim 1, wherein a pelleting press, which is preceded by at least a metering device and conditioner, and followed by a dryer and cooler, wherein a post-container and mixer follow the pelleting press.

7. The method according to claim 6, wherein the post container and mixer can be heated.

8. The method according to claim 6 wherein the mixer is designed for adding liquids and/or for drying the pellets.

9. The method according to claim 6, wherein the mixer is designed as a vacuum mixer or vacuum coater.
